(19) United States
(12) Patent Application Publication
(10) Pub. No.: US 2011/0183065 A1
(43) Pub. Date: Jul. 28, 2011

(54) Methods and apparatus for roll-coating sheet articles using metering roll of variable profile

(76) Inventors: Bill Schlegel, Union, KY (US); Joseph K. Perdue, Bowling Green, KY (US); Harvey O. Mitchell, Bowling Green, KY (US); Yihai Shi, Loyalist Township (CA); Andrew Hobbis, Kingston (CA)

(21) Appl. No.: 12/931,226

(22) Filed: Jan. 26, 2011

Related U.S. Application Data
(60) Provisional application No. 61/337,006, filed on Jan. 28, 2010.

(51) Int. Cl. B05D 5/00; B05D 1/28; B05C 1/00; B05C 9/04; B05C 9/10; B05C 11/00; B05C 13/00

(52) U.S. Cl. 427/9; 427/428.14; 427/428.15; 427/428.07; 427/428.1; 427/171; 118/200; 118/33

(57) ABSTRACT

Methods and apparatus for coating a major surface of a strip article advancing past and in contact with an applicator roll by supplying coating material to the applicator roll for transfer to the strip surface while urging a metering roll against the applicator roll to impart a coating profile to the coating material on the applicator roll before the coating material having that profile is transferred to the strip surface, wherein the metering roll is subjected to a force for bending the axis of the metering roll convexly toward the applicator roll, thereby to compensate for deflection of the metering roll that would otherwise tend to cause nonuniformity of applied coating weight across the width of the strip.

### CROSS-REFERENCE TO RELATED APPLICATION

This application claims the priority right of prior U.S. provisional patent application Ser. No. 61/337,006 filed Jan. 28, 2010, by Applicants herein. The entire contents of application Ser. No. 61/337,006 are incorporated herein for all purposes by this reference.

### BACKGROUND OF THE INVENTION

This invention relates to methods and apparatus for coating major surfaces of sheet articles such as metal strip or the like by transfer of coating material to an applicator roll and thence to the strip surface as the strip advances in a direction transverse to the roll axis, wherein the final coating profile is imparted to the coating material on the applicator roll by a metering roll that defines, with the applicator roll, a nip through which the coating material passes before transfer to the strip surface. More particularly, the invention is directed to such methods and apparatus wherein the metering roll is subjected to variation in profile by bending in order to compensate for axial deflection of the metering roll during operation and thereby to enhance uniformity of coating application across the strip width.

For purposes of illustration, but without limitation, the invention will be specifically described herein with reference to procedures and lines for coating aluminum alloy can end stock (sheet from which the ends of beverage cans are formed). Can end stock is provided with a relatively heavy lacquer coating layer on its “product-side” surface, which faces the interior of a beverage can when a lid formed from the stock is assembled with a can body, and is also provided with a different, typically thinner and lower-viscosity coating layer on its opposite, “public-side” surface, which faces outwardly in the assembled can.

Present-day can end stock coatings are applied successively by two coating stations arranged in tandem in a coating line through which a strip of the can end stock is continuously longitudinally advanced. In known types of coating lines, the coating stations may be (by way of non-limiting examples) two-roll or three-roll stations. At the first of these stations, in a typical two-roll system, the strip passes over a rigid backup roll through a nip defined between the backup roll and a coater roll or applicator roll, which is generally axially parallel to the backup roll and is urged or pressed against the strip and backup roll by mountings such as bearings engaging shaft portions extending axially from the ends of the applicator roll. A metering roll, generally axially parallel to and urged or pressed against the applicator roll, picks up coating material (lacquer) from a pan and transfers it to the surface of the applicator roll, which in turn transfers the lacquer to the product-side surface of the strip. The second station includes a second applicator roll, metering roll and pan, similar in arrangement and function to the corresponding elements of the first station, for applying a coating to the public-side strip surface; there is no backup roll at the second station, because the previously coated product-side surface is still wet, but the strip is kept taut over a relatively short unsupported distance as it passes the second station, and the public-side coating is usually of relatively lower viscosity so that less pressure is required to apply it than is needed for the product-side coating.

In an illustrative example of a known three-roll coating station, the liquid coating material is delivered to a nip between a reservoir roll and an applicator roll for transport on the applicator roll surface to the surface of the strip to be coated; a metering roll, generally axially parallel to the applicator roll, is urged against the applicator roll to impart a coating profile to the coating material thereon before the coating material is transferred from the applicator roll to the strip surface.

In the described present-day coating lines, the backup roll is a hardened steel roll. The applicator rolls have steel cores covered with a resilient material (hard rubber). The metering rolls are metal rolls with a ceramic coating.

Heretofore, can stock coating operations have tended to produce coatings that are thicker in the center of the strip than along the side edges. Such uneven thickness or coating weight is undesirable, in particular because it requires application of more coating material than would be needed if the coating were uniform in thickness across the strip width. This problem of uneven coating thickness occurs because the rolls are ground flat and there is no way to adjust for deflection of the rolls under load. Roll deflection results from the effect of gravity, present to a greater or lesser extent depending on the orientation of the coater and metering rolls, which causes the end-supported rolls to sag in the middle, and also results when force is applied to the ends of a first roll (in a direction transverse to its axis) to press it against a second roll; the applied force tends to bend the axis of the first roll concavely in such a way that the middle of the first roll is slightly farther from the second roll than are the ends of the first roll.

### SUMMARY OF THE INVENTION

The present invention, in particular aspects, contemplates the provision of a method of applying a layer of coating material to a major surface of a strip article, comprising advancing the strip article along a defined path past a rotating applicator roll urged against the article surface and having an axis transverse to the path, while supplying coating material to the applicator roll for transporting the coating material thereon and transferring the coating material therefrom to the article surface, and while urging a rotating metering roll, having an axis generally parallel to the applicator roll axis, against the applicator roll to impart a coating profile to the coating material on the applicator roll before the coating material having that profile is transferred from the applicator roll to the article surface, and while subjecting the metering roll to a bending force for bending the axis of the metering roll convexly toward the applicator roll.

In the method of the invention, the bending force applied to the metering roll compensates for deflection of the metering roll away from the applicator roll and thereby enhances the evenness of coating weight (uniformity of coating thickness) across the width of the article surface being coated. That is to say, the applied bending force tends to produce a variation in the profile of the metering roll, creating a slight crown (outwardly convex profile in the direction of the applicator roll) at its center.

Conveniently or preferably, the metering roll includes a shaft having opposed end portions respectively projecting beyond opposite ends of the metering roll and respectively engaged by members for transmitting thereto a pressing force directed generally toward the applicator roll rotational axis to press the metering roll against the applicator roll while permitting angular movement of the shaft end portions relative to the members about pivot axes transverse to the metering roll axis, and wherein the bending force is exerted on the shaft end portions outwardly of the members with respect to the metering roll and is directed generally away from the applicator roll rotational axis for bending the metering roll axis convexly toward the applicator roll.

In exemplary embodiments, the metering roll is hollow, the metering roll shaft extends lengthwise through the metering roll, the metering roll is supported on the shaft for rotation relative thereto by plural spaced bearings, and the bending force to which the metering roll is subjected acts on the shaft and is transmitted by the bearings to the metering roll. Alternatively, the shaft end portions are integral with or fixedly connected to the metering roll, and the members are bearings in which the shaft end portions rotate.

As a further feature of the invention, the method may include steps of sensing the coating thickness on the strip surface during coating and adjusting the bending force to which the metering roll is subjected to compensate for variations in sensed coating thickness.

In specific instances, the applicator roll comprises a rigid core and a resilient outer layer surrounding the core. The strip article is trained over a backup roll that defines, with the applicator roll, a nip through which the strip article passes, the applicator roll being urged against the backup roll. Moreover, when both major surfaces of the strip article are to be coated, the aforementioned applicator roll applies coating material to a first major surface of the strip article, and the method includes applying coating material to the other major surface of the strip article at a location downstream of the aforesaid applicator roll in the defined path, by advancing the strip article in taut condition past the downstream location and urging a second applicator roll against the other major surface of the strip article at the downstream location, the second applicator roll rotating about an axis transverse to the path, while supplying coating material to the second applicator roll for transporting the coating material thereon and transferring the coating material therefrom to the other major surface of the strip article, and while urging a rotating second metering roll, having an axis generally parallel to the second applicator roll axis, against the second applicator roll to impart a coating profile to the coating material on the second applicator roll before the coating material having that profile is transferred from the second applicator roll to the other major surface of the strip article, and while subjecting the second metering roll to a bending force for bending the axis of the second metering roll convexly toward the second applicator roll.

The invention in additional aspects embraces the provision of apparatus for applying a layer of coating material to a major surface of a strip article advancing along a defined path, comprising an applicator roll assembly including an applicator roll having an axis transverse to the path and a mounting rotatably supporting the applicator roll in facing relation to the article surface while urging the applicator roll against the article surface; a coating material supply providing coating material to the applicator roll for transport thereon and transfer therefrom to the article surface; a metering roll having an axis generally parallel to the applicator roll axis and a mounting rotatably supporting the metering roll while urging the metering roll into pressing contact with the applicator roll to impart a coating profile to coating material on the applicator roll before transfer of the coating material having that profile to the article surface; and roll-bending structure exerting on the metering roll a bending force for bending the metering roll axis convexly toward the applicator roll.

Other features of the apparatus, in specific embodiments, correspond to the particular method features mentioned above. Thus, the metering roll may include a shaft having end portions respectively projecting beyond opposite ends of the metering roll, the mounting for the metering roll may include members engaging the shaft end portions for transmitting thereto a pressing force directed generally toward the applicator roll rotational axis to press the metering roll against the applicator roll while permitting angular movement of the shaft end portions relative to the members about pivot axes transverse to the metering roll axis, and the roll-bending structure may exert the bending force on the shaft end portions outwardly of the members with respect to the metering roll, as a force directed generally away from the applicator roll rotational axis for bending the metering roll axis convexly toward the applicator roll. The metering roll may be hollow, with the metering roll shaft extending lengthwise therethrough and beyond the metering roll, the bending force being exerted by the roll-bending structure on the shaft, and the metering roll being supported on the shaft for rotation relative thereto by plural spaced bearings that transmit the bending force to the metering roll. In other embodiments the shaft end portions are fixedly connected to the metering roll, and the members are bearings in which the shaft end portions rotate. Also, the roll-bending structure may be mountable at any of plural locations respectively providing different angular directions of the bending force relative to the applicator roll.

Further features and advantages of the invention will be apparent from the detailed description hereinafter set forth, together with the accompanying drawings.

### BRIEF DESCRIPTION OF THE DRAWINGS

FIG. 1 is an elevational view of a can end stock roll-coating line of a type with which the present invention is concerned, in particular embodiments;

FIG. 2 is a highly simplified schematic view in explanation of the operation of the FIG. 1 coating line;

FIG. 3 is a simplified schematic perspective view of a set of rolls and the application of forces thereto in illustrative embodiments of the invention;

FIG. 4 is a highly schematic view of the assembly of metering roll, applicator roll, sheet (strip) to be coated and backup roll in the coating line of FIGS. 1 and 2, illustrating the problem overcome by the present invention;

FIG. 5 is a highly schematic view of the assembly of metering roll, applicator roll, sheet (strip) to be coated and backup roll, in an exemplary embodiment of the invention, further illustrating the directions of forces exerted on the metering roll in the practice of the present method;

FIGS. 6A and 6B are, respectively, a side view of a metering roll assembly arranged for the practice of the invention, e.g. in the embodiments represented in FIG. 3, and a diagram showing the roll deflection effected in that assembly;

FIGS. 7A and 7B are, respectively, views taken as along lines A-A and B-B of FIG. 6A;

FIGS. 8A, 8B, 8C and 8D are, respectively, a simplified perspective view, a fragmentary plan view, a fragmentary elevational view and an end view of another metering roll assembly arranged for the practice of the invention;

FIGS. 9A and 9B are, respectively, a somewhat schematic side elevational view of another metering roll assembly with which embodiments of the invention may be practiced, and a sectional view taken along line B-B of FIG. 9A;

FIGS. 10A and 10B are, respectively, a somewhat schematic side elevational view of a further metering roll assembly with which embodiments of the invention may be practiced, and a sectional view taken along line B-B of FIG. 10A;

FIG. 11 is a fragmentary view of an embodiment of the invention affording adjustability of the direction of application of metering roll bending force relative to other elements of the coating line;

FIG. 12 is a simplified schematic view of another coating line in which the present invention may be embodied and practiced; and

FIG. 13 is a similar view in further illustration of the arrangement for supplying coating material to the first applicator roll in the FIG. 12 coating line.

### DETAILED DESCRIPTION

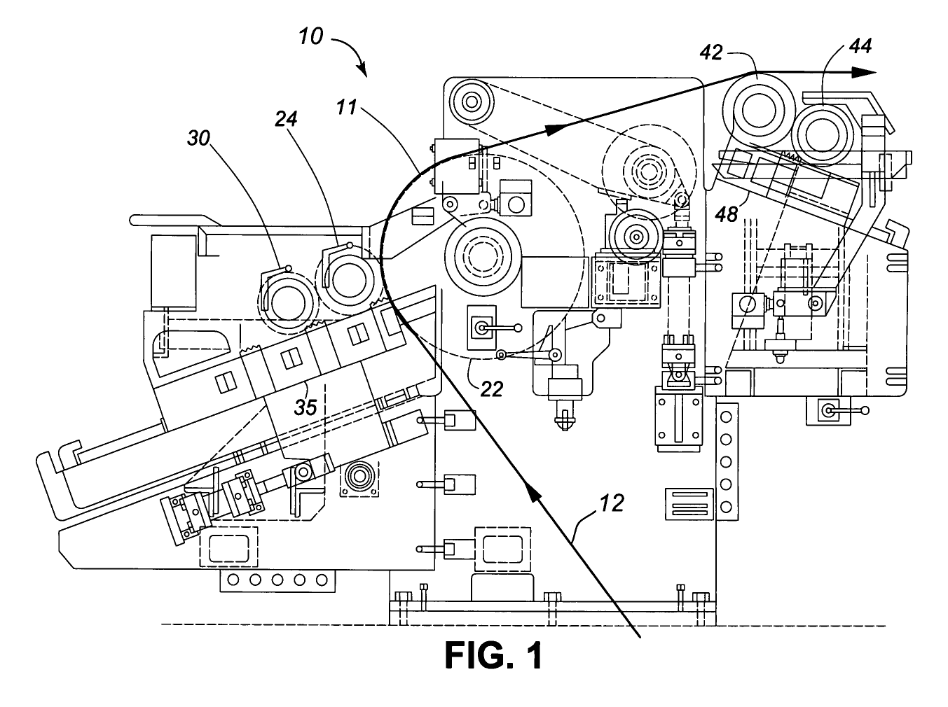

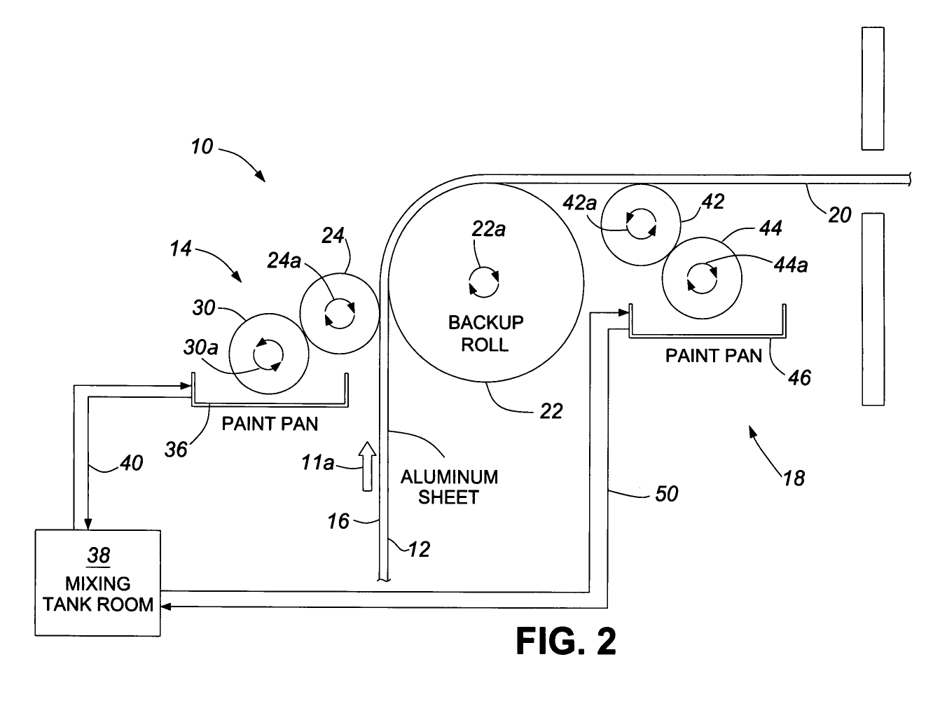

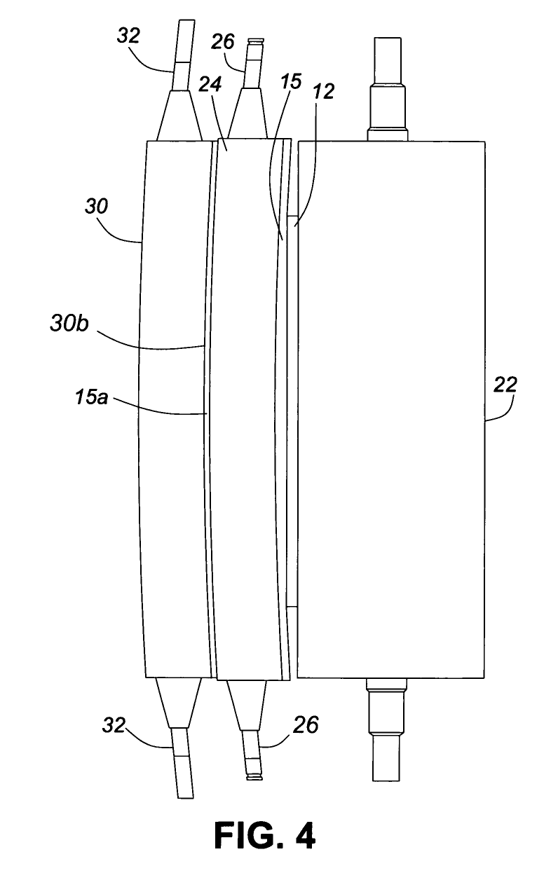

A generally conventional coating line 10 for aluminum alloy can end stock is illustrated in FIG. 1 and its operation is schematically represented in FIG. 2. As there shown, the coating line defines a path 11 for continuous longitudinal advance of a strip 12 of aluminum alloy sheet past a first coating station 14 for applying a relatively thick lacquer coating 15 (FIG. 4) to the product side surface 16 of the strip and a second coating station 18 for applying a thinner coating to the public side surface 20 of the strip at a location downstream from the first coating station in the direction of strip advance. The path-defining elements of the line 10 include a backup roll 22 over which the advancing strip is trained, as well as additional components (not shown) for cooperating with the backup roll to move the strip continuously forward along the path while maintaining the strip taut as it passes the second coating station.

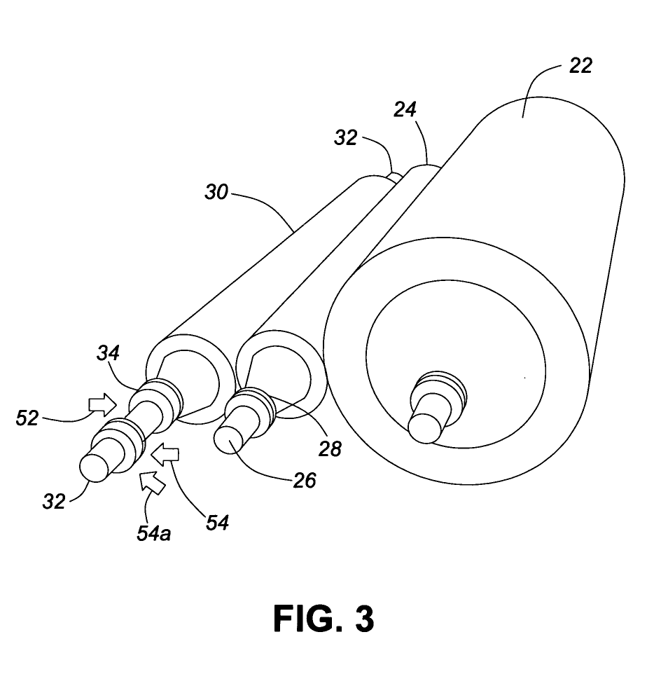

The first coating station includes a first applicator roll 24, having a hard metal core covered with resilient material such as hard rubber, disposed in proximate, generally axially parallel relation to the backup roll 22 so as to define therewith a nip through which the advancing strip 12 passes, at a point in the path 11 at which the strip is moving upwardly. Shaft end portions 26 (FIG. 3) extend outwardly from each end of the roll 24 along the roll axis and are journaled in bearings 28. In addition, the first coating station includes a first metering roll 30, which is a metal roll having a hard outer surface and is disposed in proximate, generally axially parallel relation to the applicator roll 24 on the side thereof away from the backup roll. Shaft end portions 32 (FIG. 3) extend outwardly from each end of the metering roll 30 along the axis thereof and are journaled in bearings 34. The bearings 28 and constitute mountings for the applicator and metering rolls and are themselves carried by structure 35 including hydraulic and/or mechanical devices for exerting, through the bearings and shaft end portions 26 and 32, forces directed transversely of the roll axes to urge the metering and applicator rolls against each other until a target pressure is achieved and maintained, and for then moving the metering and applicator rolls as a unit against the backup roll to achieve a target pressure between the applicator roll and the backup roll.

A first paint or coating pan 36 is positioned immediately beneath the metering roll 30 for holding a quantity of coating liquid, such as lacquer, in a position such that the metering roll 30 is partially immersed in the coating material within the pan. As the roll 30 rotates, it picks up coating material on its surface from the pan for transport to the applicator roller. For maintained supply to the pan 36, and thus to the metering roll, the coating liquid circulates between the pan and a mixing tank room 38 through a conduit system 40.

In operation of the coating line, a strip 12 of can end stock to be coated is positioned to advance in the direction of arrow 11a between the applicator roll and the backup roll 22 in path 11. The metering roll 30 and the applicator roll 24 are pressed against each other and then moved together to press the applicator roll against the strip and backup roll. With coating liquid filling the pan 36 to a sufficient level to partially immerse the metering roll 30, and with the rolls continuously rotating in the respective directions indicated by arrows 22a, 24a and 30a in FIG. 2, liquid coating material is conveyed on the surface of the metering roll 30 from the pan and, at the metering roll-applicator roll nip, is transferred as a liquid coating layer 15a to the applicator roll surface, which in turn carries the liquid coating layer to the applicator roll-backup roll nip for transfer to the product-side surface of the can end stock strip 12, so as to coat the surface 16 with a continuous layer of the coating material.

The second coating station 18, downstream of the backup roll in the strip path, includes a second applicator roll 42 (rotating in the direction indicated by arrow 42a) and a second metering roll 44 (rotating in the direction indicated by arrow 44a) with an associated second coating pan 46 respectively similar or substantially identical in structure, mounting, arrangement and function to the corresponding elements of the first coating station 14 described above. Thus, the axes of the rolls 42 and 44 are transverse to the direction of strip advance in path 11, and the two rolls have projecting shaft end portions journaled in bearings which are mounted on structure 48 including hydraulic and/or mechanical devices for exerting force on the shaft end portions to urge the rolls together and to move them as a unit so as to press the second applicator roll 42 against the advancing strip 12. Liquid coating material circulates between pan 46 and mixing tank room 38 through a conduit system 50.

The second coating station is disposed beneath the path of strip advance beyond the backup roll 22, and the second applicator roll 42 is pressed against the lower (public-side) major surface 20 of the strip 12, so as to transfer a layer of coating material to that surface. At this location, there is no backup roll opposed to the applicator roll 42 because the upper surface of the strip bears the still-wet coating layer applied at the first coating station, but the advancing strip is maintained sufficiently taut in the path 11 to permit effective transfer of a liquid coating layer to the surface 20 from applicator roll 44. Beyond the second coating station, the fully coated strip advances to further stations (not shown), e.g. for curing the applied coatings, to complete the preparation of the strip for forming into can ends.

All the rolls in FIG. 2 are independently driven, at different speeds.

Typical lacquer-based coatings as applied to can end stock in such a coating line are at a level of 1 to 8 mg/in², which equates to a coating thickness of 1 to 10 μm. Overall, coating weights may range from about 0.5 to 20 mg/in², or 0.5 to 25 μm expressed as thickness. Other parameter ranges are set forth in the table below:

| Parameter | Working Range | Preferred Range |
|---|---|---|
| strip speed (ft./min.) | 200-1500 | 400-1000 |
| (meters /min.) | 61-457 | 122-305 |
| strip width (inches) | 20-100 | 50-70 |
| (cm) | 51-254 | 127-178 |
| strip gauge (inch) | 0.007-0.08 | 0.008-0.025 |
| (cm) | 0.018-0.203 | 0.02-0.064 |

The described coating line is, as stated, generally conventional, and its components, arrangement, structure and operation are well known in the art.

In present-day can end stock coating lines, it is found that the thickness of the produced coating across the width of the sheet or strip surface exhibits a variation on the order of 0.05 to 0.25 μm (0.05 to 0.20 mg/in²), being thickest at the center of the strip and narrowest at the side edges of the strip. This undesirable variation in coating thickness is overcome by method and apparatus features of the present invention now to be described with illustrative specific reference to embodiments incorporated in coating lines of the type exemplified by that shown in FIGS. 1-2.

As stated, a force (hereinafter “coating force” or “pressing force”) is exerted on the shaft end portions extending outwardly from each of the first applicator roll 24 and first metering roll 30, to press the applicator roll and metering roll respectively against the backup roll and applicator roll. The coating force (indicated by arrow 52 in FIG. 3) acting on the metering roll is exerted through the bearings 34 on shaft end portions 32, beyond the ends of the metering roll, in a direction generally toward the applicator roll and transverse to the metering roll axis; this force, as well as gravity, tends to deflect the middle of the metering roll away from the applicator roll, as indicated at 30b in FIG. 4. It has now been discovered that the variation in coating thickness across the width of the product side surface 16 of the strip is attributable to such deflection of the first metering roll 30. Although the first applicator roll also undergoes deflection, its resilient outer cover or layer isolates the deflection of the applicator roll from any effect on metering roll-applicator roll contact or on backup roll-applicator roll contact.

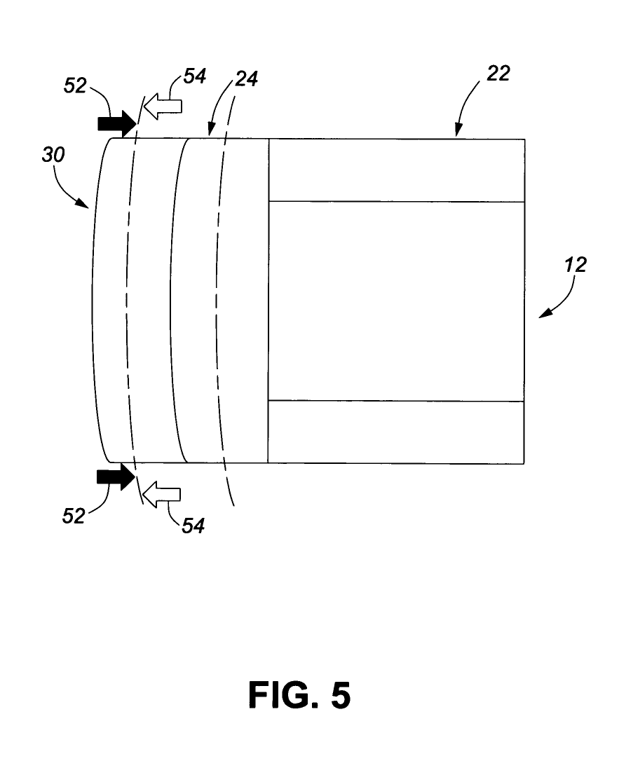

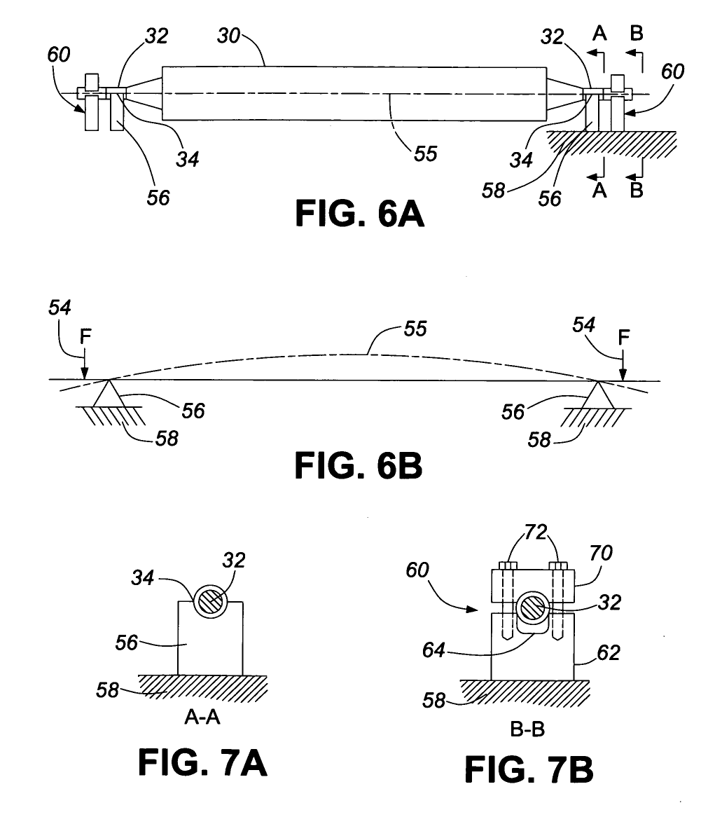

In accordance with the invention, in the embodiments herein described, the first metering roll 30 is subjected to bending to counteract the above-described deflection, to an extent sufficient to reduce or, preferably, at least substantially eliminate the variation of coating thickness across the strip surface width. The bending or roll-straightening force, indicated by arrows 54 (FIGS. 3 and 5), is exerted on each shaft end portion 32 of the first metering roll 30 outwardly of the bearings 34 with respect to the metering roll, in a direction transverse to the roll axis and generally away from the axes of the first applicator roll and the backup roll, i.e., in a direction generally opposed to that of the coating force (arrows 52) exerted on the same shaft end portions. The effect of the bending force 54 is to bend the axis 55 (FIGS. 6A and 6B) of the metering roll 30 convexly toward the applicator roll 24, to compensate for the above-described axial deflection of the metering roll away from the applicator roll and, in consequence, to enhance the uniformity of applied coating thickness across the width of the strip article surface 16.

As will be further apparent from FIGS. 6A, 6B, 9A and 10A, the point of application of the coating force 52 to each of the metering roll shaft end portions 32 serves as a fulcrum such that the bending force 54, applied to each shaft end portion 32 outwardly of that fulcrum, is able to bend the axis inwardly of the fulcrum. That is to say, the members engaging the shaft end portions to exert the coating force 52 thereon (these members being the bearings 34, in the embodiments shown in FIGS. 3, 6A, 8A and 10A) are designed to permit angular movement of the shaft end portions about pivot axes transverse to the metering roll axis for effectively transmitting the bending force to the metering roll so as to act in a direction for bending or deflecting the axis thereof as shown in FIG. 6, convexly toward the applicator roll.

Thus, as represented in FIG. 5, the bending force affects the metering roll profile, straightening the metering roll to counteract its deflection (shown in FIG. 4) away from the applicator roll under the influence of the coating force, with the result of enhancing the uniformity of the metering roll-applicator roll contact pressure along the length of the rolls. Both the coating force 52 and the bending force 54 are exerted on the metering roll throughout the strip-coating operation.

The second metering roll 44, at the second coating station 18, is similarly subjected to a coating force and a bending force acting on its shaft end portions in the same manner as in the case of the first metering roll 30, for the corresponding purpose of compensating for deflection of the middle of the metering roll away from the associated applicator roll 42 and thereby enhancing uniformity of applied coating thickness on the public-side strip surface 20.

Details of various embodiments of metering rolls for the practice of the invention are illustrated in FIGS. 6-10. In the device of FIGS. 6 and 7, supports 56 for bearings 34 are mounted on a carrier structure 58 that is acted on by mechanical and/or hydraulic devices to urge the bearing supports (and the bearings 34, in which the shaft end portions 32 are mounted) in an upward direction as seen in FIG. 6A, for pressing the metering roll against the applicator roll (not shown in FIG. 6A). Outwardly of the bearing supports, with respect to the roll 30, the shaft end portions 32 are engaged by structures 60, also mounted on carrier structure 58, for exerting on the shaft end portions a bending force in a direction generally opposite to that of the coating force. In the form shown, each structure 60 includes a block 62 secured to the carrier 58 and having a recess 64, opening toward the applicator roll, for receiving a shaft end portion 32. A second block 70, on the side of the shaft end portion opposite block 62, is adjustably secured to the block 62 by bolts 72. Tightening of the bolts 72 exerts a force on the shaft end portion pressing it into recess 64, in a direction away from the associated applicator roll; this is the bending force, which may be varied by adjustment of the bolts. As an alternative to the illustrated mechanical structure for exerting the bending force, hydraulic devices (not shown) may be employed.

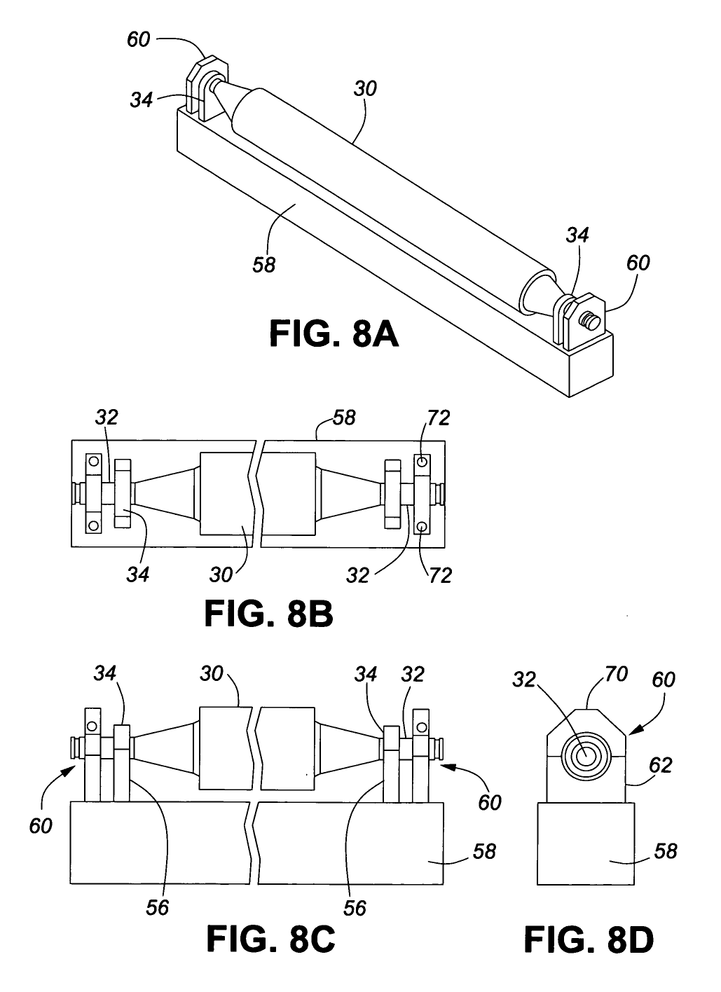

FIGS. 8A-8D illustrate another, similar metering roll and associated instrumentalities for exerting opposed coating and bending forces on the shaft end portions, identified respectively by the same reference numerals as in FIGS. 6 and 7.

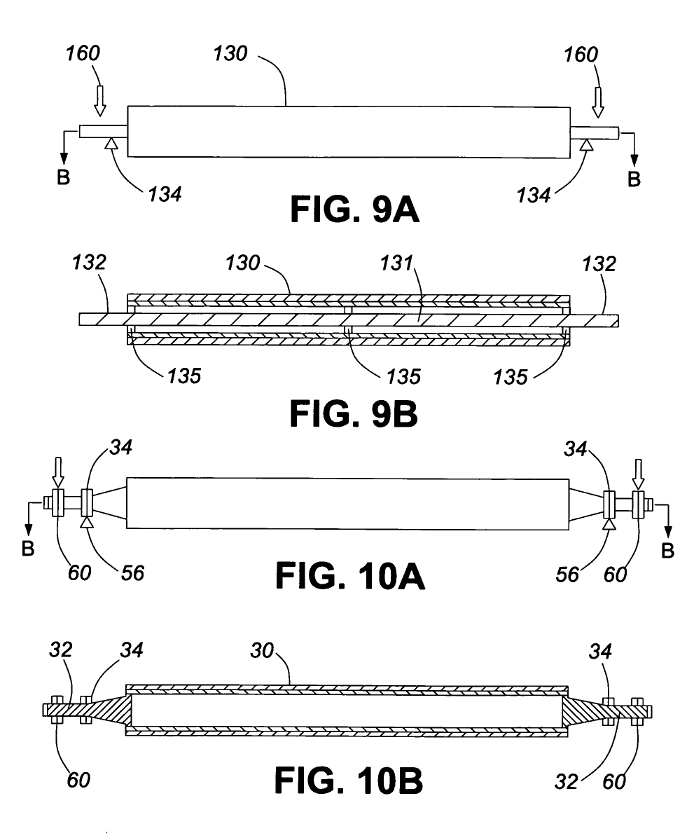

In the device of FIGS. 9A and 9B, the metering roll 130 is hollow; a fixed shaft 131 extends through it with end portions 132 projecting beyond the roll ends and is mounted on supports 134 (represented as fulcrums, FIG. 9A) which exert a coating force (corresponding to force 52 in FIG. 3) on the shaft end portions. Roll 130 is carried on plural internal bearings 135 spaced along its length that support the roll for rotation on shaft 131. Outside the supports 134, structures indicated by arrows 160 exert on the shaft end portions 132 a bending force which, owing to the fulcrum character of the supports 134, is transmitted to the middle of shaft 131 and through bearings 135 to the roll 130 for varying the roll profile, i.e., tending to bend the metering roll axis convexly toward the associated applicator roll to compensate for deflection of the middle of the roll away from the applicator roll.

In the device of FIGS. 10A and 10B, as in that of FIGS. 6-8, the metering roll 30 and shaft end portions 32 are formed integrally, with the latter journaled in bearings 34 supported on elements 56 acting as fulcrums, and (outwardly of bearings 34 with respect to the roll) in structures 60 for exerting a bending force on the roll.

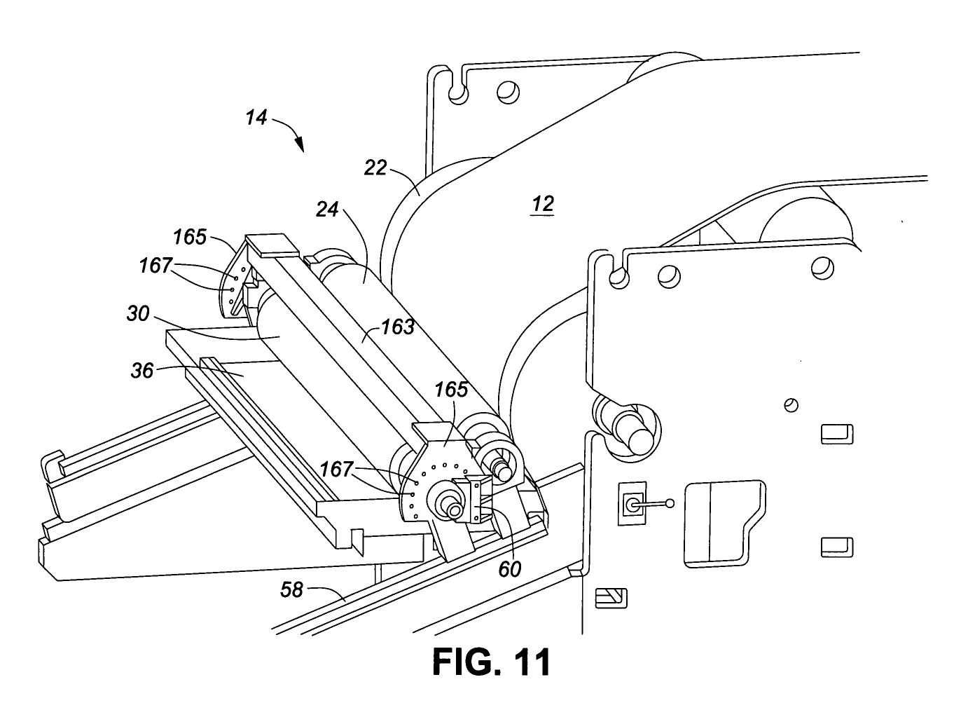

As shown in FIG. 11, the structures 60 may be selectively mountable in a plurality of different positions relative to the plane containing the rotational axes of the metering roll 30 and associated applicator roll 24 (also illustrated in FIG. 11) so that the bending force can be exerted against the metering roll shaft end portions at various degrees to the vertical and horizontal. For this purpose, the support 163 for structures 60 may include mounting brackets 165 having multiple holes 167 arranged e.g. in an arc for varying the angle at which they are secured to the carrier structure 58, as exemplified by the alternative bending force direction indicated by arrow 54a in FIG. 3.

The present invention may further include provision and use of an automated feedback/control system that acts on the structure 60 for adjusting the degree of bending force acting on the metering roll so that the roll profile can be altered on the fly, in response to changing line conditions. An example of such a system employs closed-loop control together with a scanning “SR710” infrared coating thickness gauge (supplied by NDC Infrared Engineering Ltd.) or equivalent to minimize coating thickness variation across width online.

In the coating line described above, the metering roll is in direct contact with liquid coating material in the coating pan, and serves to transfer the coating material from the pan to the applicator roll as well as to impart the final coating profile to the coating material on the applicator roll. Alternatively, the metering roll employed in the present invention can simply act to form the coating profile on the applicator roll, with the coating material being transferred to the applicator roll in some other way.

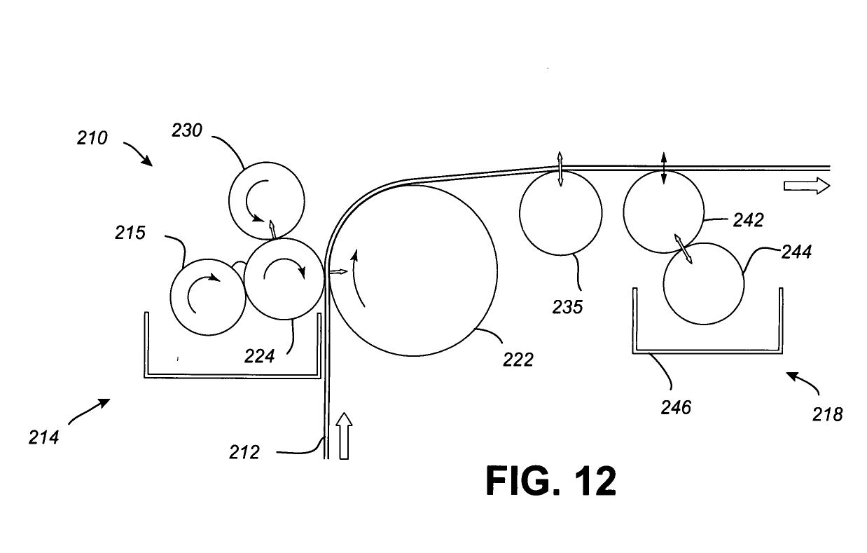

An illustrative coating line 210 of the latter type is shown in FIG. 12, for coating the product-side and public-side surfaces of the metal strip article 212. In the product-side coating station 214 of this line, there is a 3-roll arrangement wherein coating material is supplied to the nip defined between a reservoir roll 215 and a rubber coated applicator roll 224 that is axially parallel to the roll 215. The coating weight is controlled by contact pressure between a steel or ceramic-coated steel metering roll 230 and the applicator roll 224, thereby to impart a final coating profile to the coating material carried on the applicator roll surface before the coating is transferred from the applicator roll to the product-side surface of the strip article 212 at the nip between the applicator roll and a backup roll 222. The directions of rotation of the rolls at the coating station 14 are indicated by arrows. Beyond the backup roll, the strip 212 advances over a passline roll 235 to public-side coating station 218 which, in this particular coating line, may be similar to the public-side coating station 18 of FIG. 2, including an applicator roll 242 and a metering roll 244 that also serves as a pickup roll to transfer liquid coating material from a paint pan 246 to the applicator roll 242. The passline roll serves to maintain tension on the strip for application of the public-side coating in instances where the spacing between the first-station backup roll 222 and the second coating station 218 is such that strip tension at the second station might otherwise be inadequate. For simplicity, arrangements and elements for curing the applied coatings are omitted from FIG. 12.

The correction of roll deflection in accordance with the invention is applied to the metering roll 230 at coating station 214 in the coating line of FIG. 12, in the ways illustrated, for example, in FIGS. 5-10 described above, with a coating or pressing force and a counteracting bending force. Correction of roll deflection is also applied to the metering roll 244 at coating station 218.

Exemplary or suggested parameter ranges for the FIG. 12 coating line are as follows: line speed range 200-1500 ft./min. (preferably 400-1000 ft./min.); applicator roll speed between −100% and −150% of line speed (the applicator roll surface moves in the opposite direction to the strip article being coated); metering roll (230) speed between 10% and 50% of applicator roll (224) speed (the surfaces of these two rolls move in the same direction); range of force between metering and applicator rolls from 2 lb/inch to 130 lb/inch; range of force between applicator and backup rolls between 2 and 50 lb/inch total; range of bending force between metering and applicator rolls 5 lb/inch to 130 lb/inch.

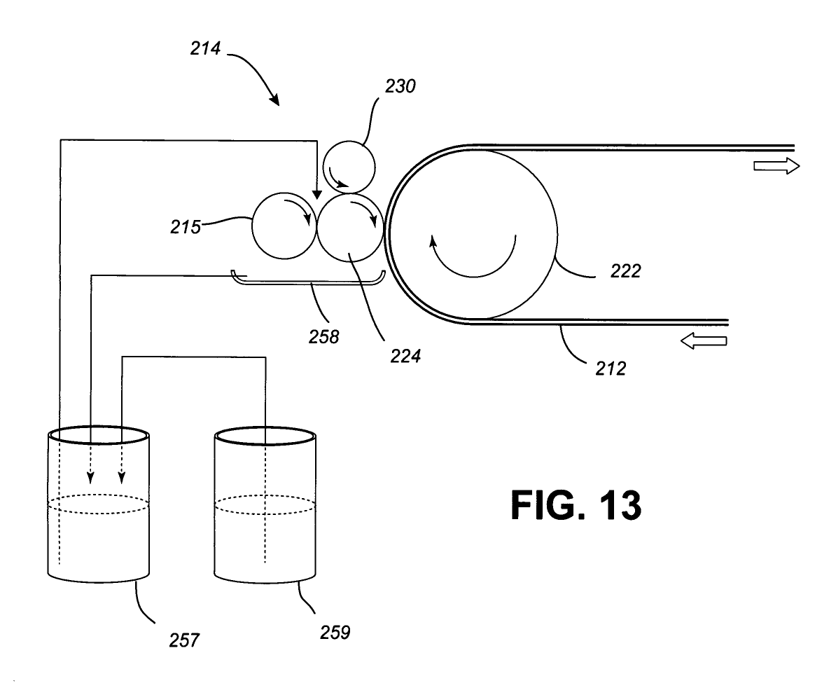

FIG. 13 is a simplified schematic illustration of one arrangement for supplying liquid coating material to the applicator roll 224 of coating station 214 in the coating line of FIG. 12. The coating material is pumped from a work drum 257 to the nip between the reservoir roll 215 and the applicator roll 224; it discharges via a wide, rectangular slot nozzle (not shown), which is about 400 mm wide (less than the coating application width); the coating flows out from the nozzle to fill the nip. It is important to maintain a sufficient depth of coating material in the nip to prevent bubbles, which could cause defects, from being drawn into the nip. The coating material supply flow rate is adjusted manually by the operator to match the application rate.

Coating material that flows off edges of the reservoir in the nip is caught in a recycle pan 258 and returned to the work drum 257, where it is augmented with additional coating material from a supply drum 259 for delivery to the nip as described above.

For simplicity, the public-side coating station 218 is omitted from FIG. 13.

It is to be understood that the invention is not limited to the features and embodiments hereinabove specifically set forth, but may be carried out in other ways without departure from its spirit.

What is claimed is:

1. A method of applying a layer of coating material to a major surface of a strip article, comprising
(a) advancing the strip article along a defined path past a rotating applicator roll urged against said article surface and having an axis transverse to the path, while
(b) supplying coating material to the applicator roll for transporting the coating material thereon and transferring the coating material therefrom to said article surface, and while
(c) urging a rotating metering roll, having an axis generally parallel to the applicator roll axis, against the applicator roll to impart a coating profile to the coating material on the applicator roll before the coating material having said profile is transferred from the applicator roll to said article surface, and while
(d) subjecting the metering roll to a bending force for bending the axis of the metering roll convexly toward the applicator roll.

2. A method according to claim 1, wherein the supplying step comprises supplying coating material to said metering roll such that the supplied coating material is transferred from the metering roll to the applicator roll.

3. A method according to claim 1, wherein the metering roll includes a shaft having opposed end portions respectively projecting beyond opposite ends of the metering roll and respectively engaged by members for transmitting thereto a pressing force directed generally toward the applicator roll rotational axis to press the metering roll against the applicator roll while permitting angular movement of the shaft end portions relative to said members about pivot axes transverse to the metering roll axis, and wherein said bending force is exerted on the shaft end portions outwardly of the members with respect to the metering roll and is directed generally away from the applicator roll rotational axis for bending the metering roll axis convexly toward the applicator roll.

4. A method according to claim 3, wherein the metering roll is hollow, wherein the metering roll shaft extends lengthwise through the metering roll, the metering roll is supported on the shaft for rotation relative thereto by plural spaced bearings, and the bending force to which the metering roll is subjected acts on the shaft and is transmitted by said bearings to the metering roll.

5. A method according to claim 3, wherein the shaft end portions are integral with or fixedly connected to the metering roll, and wherein said members are bearings in which said shaft end portions rotate.

6. A method according to claim 1, including sensing the coating thickness on the strip surface during coating and adjusting the bending force to which the metering roll is subjected to compensate for variations in sensed coating thickness.

7. A method according to claim 1, wherein the applicator roll comprises a rigid core and a resilient outer layer surrounding the core.

8. A method according to claim 7, wherein the strip article is trained over a backup roll that defines, with the applicator roll, a nip through which the strip article passes, the applicator roll being urged against the backup roll.

9. A method according to claim 8, wherein the strip article has opposed major surfaces to be coated, wherein said applicator roll applies coating material to a first major surface of the strip article, and further including applying coating material to the other major surface of the strip article at a location downstream of the aforesaid applicator roll in the defined path, by advancing the strip article in taut condition past the downstream location and urging a second applicator roll against the other major surface of the strip article at the downstream location, the second applicator roll rotating about an axis transverse to the path, while supplying coating material to the second applicator roll for transporting the coating material thereon and transferring the coating material therefrom to the other major surface of the strip article, and while urging a rotating second metering roll, having an axis generally parallel to the second applicator roll axis, against the second applicator roll to impart a coating profile to the coating material on the second applicator roll before the coating material having that profile is transferred from the second applicator roll to the other major surface of the strip article, and while subjecting the second metering roll to a bending force for bending the axis of the second metering roll convexly toward the second applicator roll.

10. A method according to claim 9, wherein the step of supplying coating material to the second applicator roll comprises supplying the coating material to the second metering roll such that the supplied coating material is transferred from the second metering roll to the second applicator roll and thence to said other major surface to be coated.

11. In apparatus for applying a layer of coating material to a major surface of a strip article advancing along a defined path, in combination:
(a) an applicator roll assembly including an applicator roll having an axis transverse to the path and a mounting rotatably supporting the applicator roll in facing relation to said article surface while urging the applicator roll against said article surface;
(b) a coating material supply providing coating material to the applicator roll for transport thereon and transfer therefrom to said article surface;
(c) a metering roll having an axis generally parallel to said applicator roll axis and a mounting rotatably supporting the metering roll while urging the metering roll into pressing contact with the applicator roll to impart a coating profile to coating material on the applicator roll before transfer of the coating material having said profile to said article surface; and
(d) roll-bending structure exerting on the metering roll a bending force for bending the metering roll axis convexly toward the applicator roll.

12. Apparatus as defined in claim 11, wherein said coating material supply provides coating material to the metering roll for transfer to the applicator roll and thence to the article surface to be coated.

13. Apparatus as defined in claim 11, wherein the metering roll includes a shaft having end portions respectively projecting beyond opposite ends of the metering roll, wherein the mounting for the metering roll includes members respectively engaging the shaft end portions for transmitting thereto a pressing force directed generally toward the applicator roll rotational axis to press the metering roll against the applicator roll while permitting angular movement of the shaft end portions relative to said members about pivot axes transverse to the metering roll axis, and wherein the roll-bending structure exerts said bending force on the shaft end portions outwardly of the members with respect to the metering roll, as a force directed generally away from the applicator roll rotational axis for bending the metering roll axis convexly toward the applicator roll.

14. Apparatus as defined in claim 13, wherein the metering roll is hollow, the metering roll shaft extends lengthwise through and beyond the metering roll, the bending force exerted by the roll-bending structure acts on the shaft, and the metering roll is supported on the shaft for rotation relative thereto by plural spaced bearings that transmit said bending force to the metering roll.

15. Apparatus as defined in claim 13, wherein the shaft end portions are fixedly connected to the metering roll, and wherein said members are bearings in which said shaft end portions rotate.

16. Apparatus as defined in claim 11, wherein the roll-deflecting structure is mountable, relative to said members, at any of plural locations respectively providing different angular directions of exertion of said bending force relative to the applicator roll.

17. Apparatus as defined in claim 11, wherein the applicator roll comprises a rigid core and a resilient outer layer surrounding the core.

18. Apparatus as defined in claim 17, further including a backup roll that defines, with the applicator roll, a nip through which the strip article passes, the applicator roll being urged against the backup roll.

19. Apparatus as defined in claim 18, wherein the strip article has opposed major surfaces to be coated and said applicator roll applies coating material to a first major surface of the strip article, further including
(e) a second applicator roll assembly including a second applicator roll and a mounting supporting the second applicator roll for rotation about an axis transverse to the path and in facing relation to the other major surface to be coated at a location in the defined path downstream of the first-mentioned applicator roll, while urging the second applicator roll into pressing contact with said surface, the strip being advanced in taut condition past said downstream location;
(f) a second metering roll having an axis and a mounting supporting the second metering roll for rotation with the second metering roll axis generally parallel to the second applicator roll rotational axis while urging the second metering roll into pressing contact with the second applicator roll;
(g) a second coating material supply providing coating material to the second metering roll for transfer to the second applicator roll and thence to said other major surface; and
(h) second roll-bending structure exerting on the second metering roll a bending force for bending the second metering roll axis convexly toward the second applicator roll.

20. In a method of applying a layer of coating material to a major surface of a strip article, the steps of:
(a) advancing the strip article along a defined path past a rotating applicator roll urged against said article surface and having an axis transverse to the path, while
(b) transporting coating material on the applicator roll toward said path for transfer from the applicator roll to said article surface, and while
(c) urging a rotating metering roll, having an axis generally parallel to the applicator roll axis, against the applicator roll to impart a coating profile to the coating material on the applicator roll before the coating material having said profile is transferred from the applicator roll to said article surface, and while
(c) bending the axis of the metering roll convexly toward the applicator roll to compensate for axial deflection of the metering roll away from the applicator roll and thereby to enhance uniformity of coating thickness across the width of the strip article.
